(19) United States
(12) Patent Application Publication
(10) Pub. No.: US 2022/0291501 A1
(43) Pub. Date: Sep. 15, 2022

(54) SYSTEM AND METHOD FOR FACILITATING OPTICAL RASTER SCANNING

(71) Applicant: Oak Analytics Inc., Camarillo, CA (US)

(72) Inventors: Ruibo Wang, Camarillo, CA (US); James F. Gass, Camarillo, CA (US)

(73) Assignee: Oak Analytics Inc., Camarillo, CA (US)

(21) Appl. No.: 17/681,537

(22) Filed: Feb. 25, 2022

Related U.S. Application Data
(60) Provisional application No. 63/159,285, filed on Mar. 10, 2021.

(51) Int. Cl. G02B 26/10; G01J 3/02; G01J 3/06

(52) U.S. Cl. CPC G02B 26/101; G01J 3/0208; G01J 3/06; G01J 2003/062

(57) ABSTRACT

One embodiment provides an apparatus for facilitating raster scanning of an optical spectrometer. The apparatus can include an enclosure, a lens holder situated within the enclosure, and an actuation mechanism coupled to the lens holder. The lens holder is configured to hold a lens that focuses excitation light onto a sample surface, and the actuation mechanism is configured to cause the lens holder to perform a motion according to a predetermined pattern, thereby causing the focused excitation light to raster scan the sample surface.

### RELATED APPLICATION

This application claims the benefit of U.S. Provisional Application No. 63/159,285, Attorney Docket Number OKA21-1001PSP, titled “System and Method for Facilitating Optical Raster Scanning,” by inventors Ruibo Wang and James F. Gass, filed on 10 Mar. 2021, the disclosure of which is incorporated herein by reference in its entirety.

### BACKGROUND

### Field

This disclosure is generally related to optical spectrometers. More specifically, this disclosure is related to implementing raster scanning in optical spectrometers.

### Related Art

Optical spectrometers that rely on the detection of reflected and scattered light to perform spectral analysis typically detect very weak signals. For example, a Raman spectrometer can use a laser beam to excite inelastic scattering (also known as Raman scattering) of photons, and the returning Raman scattered signal can be one million times weaker than the excitation source. Because the signals of interest are so weak, the detection of low concentration elements in the sample often uses high power densities of excitation light as well as prolonged exposure times (e.g., typically 1-10 seconds). The most common way to achieve a higher power density for a given source is by focusing the excitation source to a very small spot size, typically under 100 microns in diameter.

This extremely small spot size of the excitation source can present two main challenges in applications of Raman spectrometers. First, the high power density and the prolonged exposure time of the excitation source may damage the sample, or even cause a fire or explosion for certain sample types. Second, measurement on non-homogeneous samples can be challenging as it involves performing many measurements in different physical locations to ensure that all contents of the sample are measured accurately and repeatably.

### SUMMARY

One embodiment provides an apparatus for facilitating raster scanning of an optical spectrometer. The apparatus can include an enclosure, a lens holder situated within the enclosure, and an actuation mechanism coupled to the lens holder. The lens holder is configured to hold a lens that focuses excitation light onto a sample surface, and the actuation mechanism is configured to cause the lens holder to perform a motion according to a predetermined pattern, thereby causing the focused excitation light to raster scan the sample surface.

In a variation on this embodiment, the lens holder is mechanically coupled to internal walls of the enclosure via one or more springs, and the actuation mechanism comprises at least one motor configured to compress or expand the springs.

In a further variation, the at least one motor is a vibration motor, and the springs are flat springs.

In a further variation, the at least one motor is a rotation motor configured to cause the lens holder to rotate off axis.

In a further variation, the at least one motor comprises a hollow core, and the lens holder and the one or more springs are situated inside the hollow core.

In a variation on this embodiment, the lens holder is coupled to a shaking plate, and the actuation mechanism comprises at least one motor configured to cause the shaking plate to move in a plane perpendicular to an optical axis of the lens.

In a variation on this embodiment, the lens holder is coupled to a linear rail system, and the actuation mechanism comprises a voice coil actuator.

In a variation on this embodiment, the apparatus further comprises a constraint mechanism configured to constrain motions of the lens holder to a plane that is substantially perpendicular to an optical axis of the lens.

In a variation on this embodiment, the apparatus further comprises a light-blocking mechanism surrounding the lens holder configured to prevent light from circumventing the lens holder to reach the detector.

In a variation on this embodiment, the apparatus further comprises an actuation control mechanism configured to control one or more parameters of the actuation mechanism in order to control a motion pattern of the lens holder.

One embodiment provides an optical spectrometer. The optical spectrometer can include a light source configured to provide excitation light, an excitation lens system configured to focus the excitation light onto a sample surface, and a detector configured to detect signals excited by the excitation light from the sample surface. The excitation lens system comprises a lens and an actuation mechanism coupled to the lens, and the actuation mechanism is configured to cause the lens to perform a motion according to a predetermined pattern, thereby causing the focused excitation light to raster scan the sample surface.

### BRIEF DESCRIPTION OF THE FIGURES

FIG. 1 illustrates an exemplary setup of a Raman spectrometer, according to prior art.

FIG. 2A illustrates an exemplary setup of a Raman spectrometer implementing raster scanning, according to one embodiment.

FIG. 2B illustrates an exemplary movement scenario of moving lens 206, according to one embodiment.

FIG. 3A illustrates the front view of an exemplary lens-motion system, according to one embodiment.

FIG. 3B illustrates the side view of lens-motion system 300, according to one embodiment.

FIG. 4A illustrates the front view of an exemplary unibody lens-motion system, according to one embodiment.

FIG. 4B illustrates the perspective view of unibody lens-motion system 400, according to one embodiment.

FIG. 5A illustrates an exemplary rotation-based lens-motion system, according to one embodiment.

FIG. 5B illustrates an exemplary rotation-based lens-motion system, according to one embodiment.

FIG. 6 illustrates an exemplary lens-motion system with a linear-bearing configuration, according to one embodiment.

FIG. 7 illustrates an exemplary lens-motion system with linear rails, according to one embodiment.

FIG. 8A illustrates the sideview of a lens-motion system implementing a light-blocking structure, according to one embodiment.

FIG. 8B shows the perspective view of the lens-motion system implementing the light-blocking structure, according to one embodiment.

FIG. 9 presents a flowchart illustrating an exemplary process for measuring the optical spectrum of a sample, according to one embodiment.

FIG. 10 illustrates a block diagram of a spectrometer implementing raster scanning, according to one embodiment.

In the figures, like reference numerals refer to the same figure elements.

### DETAILED DESCRIPTION

The following description is presented to enable any person skilled in the art to make and use the embodiments and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown but is to be accorded the widest scope consistent with the principles and features disclosed herein.

### Overview

Embodiments described herein solve the technical problem of enabling raster scanning in Raman spectrometers. Instead of moving the sample or using a mirror to steer the exciting laser beam, in some embodiments of the present application, the lens system (e.g., a lens barrel) that focuses the exciting laser beam onto the sample is configured to move in a plane perpendicular to the optical path to achieve raster scanning. In one embodiment, the lens barrel can be attached to a system of springs and one or more motors can disturb the springs, thus causing the lens barrel to move within the perpendicular plane according to a predetermined raster pattern. In addition to springs, other mechanisms, such as off-centered rotation, a shaking plate, or a stacked linear rail system, can also be used to achieve the raster of the laser beam. In addition, the lens system can also be enclosed in a multiwalled housing to prevent light leakage.

Raman Spectrometer with Raster Scanning

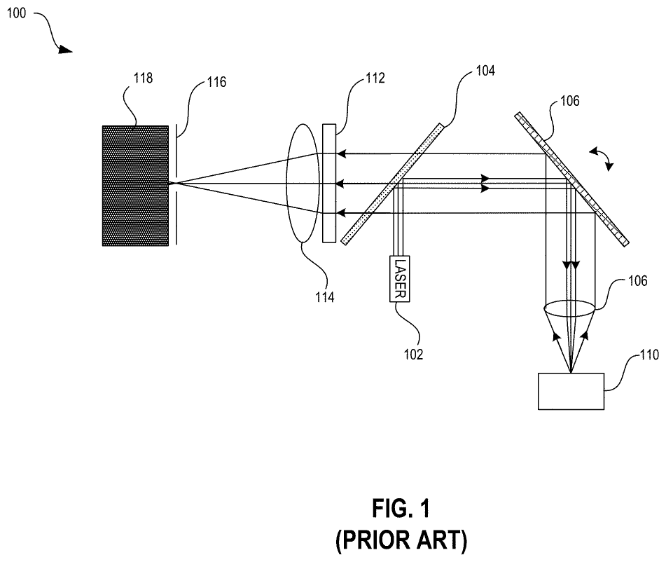

FIG. 1 illustrates an exemplary setup of a Raman spectrometer, according to prior art. Raman spectrometer 100 can include an excitation source (e.g., a laser 102), a dichroic filter 104, a mirror 106, a first lens 108, a sample 110, a longpass filter 112, a second lens 114, a slit 116, and a dispersive-and-detection optical module 118.

During operation, a laser beam emitted from laser 102 is reflected by dichroic filter 104, which is configured to block/reflect the laser wavelength, and mirror 106. The reflected laser beam is then focused by first lens 108 onto the surface of sample 110. Excited Raman signals can be collected by first lens 108 and reflected by mirror 106 and then pass through dichroic filter 104 (which is configured to pass the Raman wavelength) and longpass filter 112 before being focused by second lens 114. Second lens 114 focuses the Raman signals onto slit 116, which is placed in front of dispersive-and-detection optical module 118 to block noise. Dispersive-and-detection optical module 118 can facilitate spectra analysis on the Raman signals. For example, dispersive-and-detection optical module can include dispersive optics for dispersing the Raman signals and a detector for detecting the dispersed signal.

To prevent the sample from being exposed to high-intensity light for a prolonged period and to increase the measurement area, raster scanning of the sample surface has been proposed. Raster scanning refers to the act of rapidly and continuously moving the focused excitation spot around the sample, such that the measured Raman signals are averaged over the scanned area. For example, if the focused excitation spot has a diameter of around 100 microns, the raster scanning area (i.e., the area within which the focused spot moves around) can have a diameter of a few millimeters (e.g., two millimeters). Raster scanning can lower the overall power density on a sample (for a given exposure time) as well as increase the sampling area without sacrificing the benefits of a small spot size. With raster scanning, the exposure time per unit area can be decreased, thus allowing the sample to dissipate the received excitation energy without being damaged. Also, the spectrum returned from the larger area can better represent the sample, because any non-uniformities are averaged out with the signal collected from the entire scanned area.

One way to accomplish raster scanning is to move the sample several times (or continuously) during exposure to form a composite return signal. However, moving the sample (or the whole spectrometer) is often undesirable and sometimes not feasible. Another approach for raster scanning can involve moving mirror 106 in order to steer the beam from the excitation source (e.g., laser 102). However, this approach can have several disadvantages. For example, in a confocal system as shown in FIG. 1, the excitation source (e.g., laser 102) must be reflected by a 45° filter (e.g., dichroic filter 104) to simultaneously block the reflected light of the excitation wavelength and allow the return signal to reach dispersive-and-detection optical module 118. Dichroic filter 104 is sensitive to the angle of incident light. If the excitation beam is oversteered (e.g., by mirror 106), then dichroic filter 104 may not perform adequately in blocking the reflected excitation light from reaching dispersive-and-detection optical module 118. Once reaching dispersive-and-detection optical module 118, the reflected excitation light may saturate the detector or cause errors in the detected spectrum. In addition, this raster scanning approach can require additional and sometimes costly optical components in the light path. For example, mirror 106 can be microelectromechanical system (MEMS)-based. MEMS mirrors can be costly and often have a limited movement range. The additional components cause added difficulty in aligning the excitation source properly. Similar to the above scenario of oversteering, improper alignment will cause a poor angle of incidence on the 45° filter, which may allow the excitation light to reach dispersive-and-detection optical module 118.

To achieve raster scanning without the above problems, in some embodiments of the instant application, the lens focusing the excitation light onto the sample can move within a plane perpendicular to the optical path of the light excitation, thus steering the focused beam spot on the sample to form a raster pattern. More specifically, the excitation beam spot and the lens move together with a 1:1 ratio. In other words, a one-millimeter displacement of the lens can result in a one-millimeter displacement of the excitation beam spot.

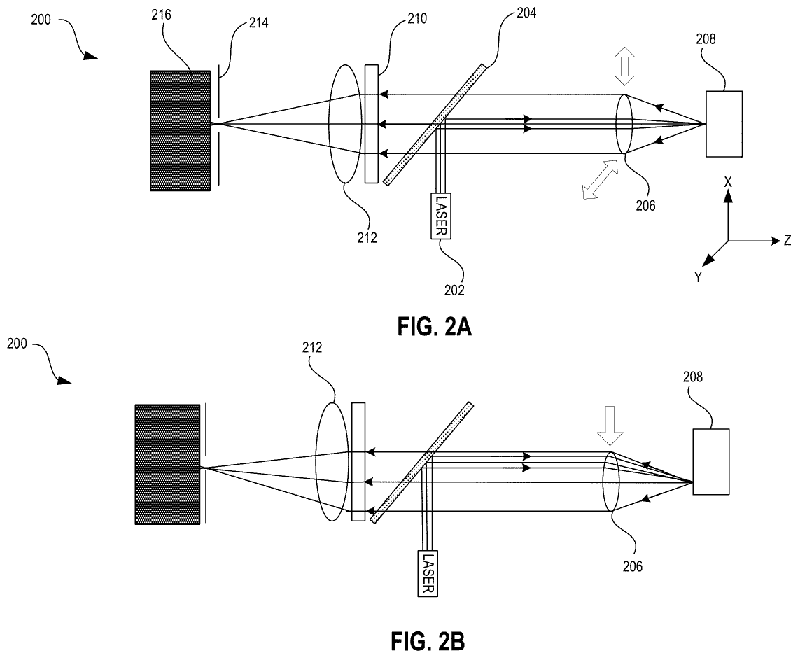

FIG. 2A illustrates an exemplary setup of a Raman spectrometer implementing raster scanning, according to one embodiment. Raman spectrometer 200 can include an excitation source (e.g., a laser 202), a dichroic filter 204, a moving lens 206, a sample 208, a longpass filter 210, a fixed lens 212, a slit 214, and a dispersive-and-detection optical module 216.

Laser 202 can be a diode laser capable of producing high-intensity light at Raman excitation wavelengths (e.g., 785 nm). During measurement, a laser beam emitted from laser 202 can be reflected by dichroic filter 204 and focused, along the Z-axis, by moving lens 206 onto the surface of sample 208. In this example, the Z-axis can be along the optical axis of moving lens 206 and fixed lens 212. Because the moving lens 206 focuses the excitation light, it can also be referred to as the excitation lens. When moving lens 206 moves in the X-Y plane (as indicated by the hollow double arrows) so will the focused beam spot of the excitation light. The focused excitation light excites Raman signals from the sample, and the scattered Raman signals can be collected by moving lens 206 and can pass through dichroic filter 204 and longpass filter 210 before being focused by fixed lens 212. Unlike moving lens 206, the location of fixed lens 212 remains unchanged. Fixed lens 212 focuses the Raman signals onto slit 214, which is placed in front of dispersive-and-detection optical module 216.

Compared with the spectrometer shown in FIG. 1, spectrometer 200 shown in FIG. 2A does not require an additional moving mirror to steer the excitation beam, thus reducing cost, simplifying alignment, and increasing system stability. Because the incident angle of excitation light (i.e., excitation light from laser 202) to dichroic filter 204 remains unchanged, it is unlikely that the excitation light enters dispersive-and-detection optical module 216. Moreover, because moving lens 206 only moves within the X-Y plane, its movements does not cause changes in the incident angle of the Raman signals.

FIG. 2B illustrates an exemplary movement scenario of moving lens 206, according to one embodiment. In FIG. 2B, moving lens 206 moves downward along the X-axis (as shown by the hollow arrow). Correspondingly, the focused beam spot moves downward to a different location on the surface of sample 208. Note that for ease of illustration, the displacement of moving lens 206 is exaggerated in FIG. 2B, which shows the returned Raman scattered light being significantly off center of fixed lens 212. In practice, the scanning area is typically limited to a relatively small area (e.g., a circle with a diameter of a few millimeters) compared with the size of fixed lens 212. Consequently, moving lens 206 only needs to move within a correspondingly small area, and the returned Raman scattered light can be close to the optical axis of fixed lens 212.

### Spring-Based Raster Scanning

Different mechanisms can be used to provide planar movement of the excitation lens (i.e., moving lens 206 shown in FIGS. 2A and 2B). In some embodiments, a lens-motion system that includes springs and vibration motors can be used to enable the planar movement of the lens. More specifically, the excitation lens can be attached to a spring system comprising multiple springs. The forces and counterforces generated by the springs can keep the excitation lens at a particular location. One or more vibration motors can be used to disturb one or more springs, causing the springs to expand or compress, thus moving the excitation lens within the same expanding or compressing plane of the springs.

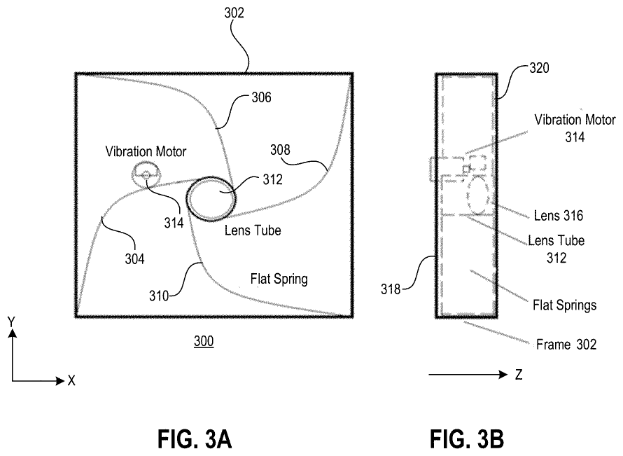

FIG. 3A illustrates the front view of an exemplary lens-motion system, according to one embodiment. A lens-motion system 300 can include a frame 302, a number of flat springs (e.g., flat springs 304-310) attached to frame 302, a lens tube 312 supported by the flat springs, and a vibration motor 314.

Frame 302 can be a physical enclosure that encloses all other components of lens-motion system 300. In some embodiments, frame 302 can be made of a rigid material and can remain stationary during the operation of the spectrometer. A flat spring can be made of a flat strip of material, typically metal. They have different shapes and sizes. In the example shown in FIG. 3A, each flat spring can be a tension spring with a curved surface, with the end portion of the flat spring wrapping around a portion of lens tube 312. The flat springs can be arranged in such a way that they are coupled to each other, and a tension force applied onto one spring can propagate to other springs. In the example shown in FIG. 3A, the curved surfaces of all flat springs can form a windmill pattern, with the convex surfaces of the flat springs aligned clockwise. Note that other arrangements are also possible. For example, the convex surfaces of the flat springs can also be aligned counterclockwise. Moreover, the number of flat springs can also be different from what is shown in FIG. 3A. In one embodiment, a single flat spring can be used to wrap around lens tube 312.

Lens tube 312 can enclose the excitation lens. In many applications, the excitation lens can be a compound lens that includes multiple (e.g., two) thin lenses. In one embodiment, lens tube 312 can enclose achromatic lenses (e.g., an achromatic doublet). Lens tube 312 can be supported and mechanically coupled to all flat springs such that deformation of any flat spring can cause displacement of lens tube 312. In the example shown in FIG. 3A, the end portion of each flat spring wraps around a portion of lens tube 312. The forces and counterforces applied by the flat springs keep lens tube 312 in position. Because the flat springs are substantially identical in shape and are symmetrically arranged, when the flat springs are not deformed or disturbed, lens tube 312 is positioned substantially in the center of frame 302. Other arrangements are also possible. For example, the flat springs can have different shapes and/or lengths, and, when the flat springs are undisturbed, lens tube 312 can be positioned at a location away from the center of frame 312.

Vibration motor 314 can be attached to one of the flat springs (e.g., flat spring 304). When vibration motor 314 vibrates (or wobbles), flat spring 304 is deformed (e.g., compressed and expanded), causing lens tube 312 to move along with flat spring 304. The continuous vibration of vibration motor 314 can lead to continuous motion of lens tube 312. In one embodiment, the vibration or wobbling of vibration motor 314 can result in a circular motion of lens tube 312, and the radius of the circle can depend on the amplitude of the vibration. The amplitude of the vibration can depend on the stiffness of the spring and/or the parameters (e.g., the drive strength) of vibration motor 314. In other words, a particular raster pattern can be obtained by carefully selecting and configuring parameters associated with the springs and vibration motor 314. In further embodiments, the drive strength of vibration motor 314 can vary in time to produce a time-varying raster pattern (e.g., a spiral pattern). If the drive strength varies with time periodically, the raster pattern can also vary with time periodically. For example, in most applications, for each measurement, the sample may be exposed to the excitation light for a duration between 1 and 10 seconds. In such a situation, the drive strength may vary with time at a frequency of about 10 Hz. Consequently, the raster pattern can also vary with time at a frequency of about 10 Hz.

In the example shown in FIG. 3A, there is only one vibration motor. In practice, there can be multiple vibration motors, which can also be configured to vibrate at different speeds and/or amplitudes. The multiple asynchronous motors can produce raster patterns that are more complex than the circular or spiral pattern. In one embodiment, the raster pattern can be a random pattern. The motors and springs should be chosen so that they allow the excitation lens to have sufficient planar movement for the application (some applications may require greater movement than others). In fact, there can be many possible motor and spring combinations, and the exact configuration should be chosen to optimize a given application.

It is important to note that the moving lens should be constrained such that the moving lens does not experience angular displacement with regard to the system's optical path (i.e., along the Z-axis). If the lens angle changes, then the returned Raman signals may not be properly focused onto the detector. Flat springs can be advantageous in this regard because they typically resist rotation along their width. In addition, frame 302 can also include opposite flat walls that can confine the movements of lens tube 312 to be within the X-Y plane.

FIG. 3B illustrates the side view of lens-motion system 300, according to one embodiment. More specifically, FIG. 3B shows a lens 316 being enclosed within lens tube 312. FIG. 3B also shows that opposite walls 318 and 320 of frame 302 enclose the flat springs and lens tube 312, so that when the flat springs are driven or actuated by vibration motor 314, movements of lens tube 312 is confined between opposite flat walls 318 and 320. In addition to confining lens tube 312, opposite flat walls 318 and 320 can also block light outside of lens tube 312 from entering the optical path to reach the detector.

In addition to flat springs, other types of spring, such as wire or coil springs, can also be used in the lens-motion system to move the excitation lens, as long as there is a restraining system that confines movements of the excitation lens in the X-Y plane. Moreover, in addition to having the flat springs attached to a rigid body, in some embodiments, the lens-motion system can be a unibody construction where the springs are a single piece together with the outer frame. In one embodiment, a mold material, such as plastic, silicon, or rubber, can be used to construct the unibody lens-motion system.

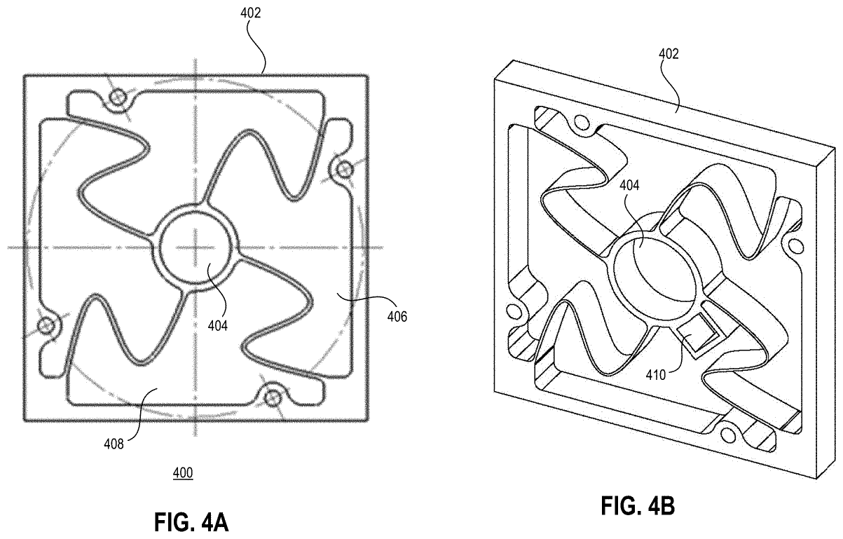

FIG. 4A illustrates the front view of an exemplary unibody lens-motion system, according to one embodiment. Unibody lens-motion system 400 can include a body 402, a lens-tube cavity 404, and a number of cavities enclosed by body 402 (e.g., cavities 406 and 408). More specifically, body 402 can be single continuous piece of material that is molded to include both an outer frame and a number of flat springs. Lens-tube cavity 404 can be substantially at the center of body 402 and can enclose the excitation lens. Each pair of adjacent flat springs can form a cavity (e.g., cavity 406 or 408). These cavities provide room for the flat springs to move.

FIG. 4B illustrates the perspective view of unibody lens-motion system 400, according to one embodiment. The perspective view shows more clearly that body 402 is a continuous single piece, where the flat springs are connected to the outer frame. FIG. 4B also shows a motor cavity 410 (which is omitted in FIG. 4A). Motor cavity 410 can enclose a vibration motor, the vibration of which can cause the flat springs to deform, thus causing the excitation lens enclosed in lens-tube cavity 404 to move.

The operation principle of unibody lens-motion system 400 can be very similar to that of lens-motion system 300 shown in FIGS. 3A and 3B. The unibody construction has the advantage of requiring little assembly and being low cost. The spring constant (or the stiffness of the spring) can be fine-tuned through material selection and spring geometry. The non-metal springs also have an advantage in high humidity environments where metal springs would tend to rust.

### Rotation-Based Raster Scanning

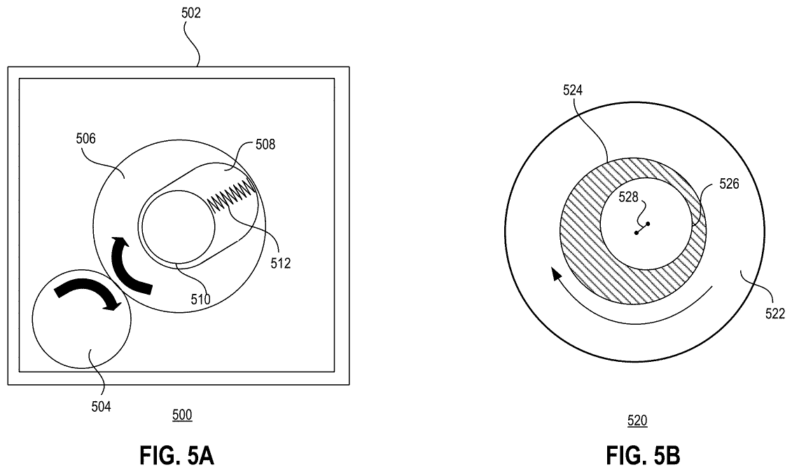

FIG. 5A illustrates an exemplary rotation-based lens-motion system, according to one embodiment. Lens-motion system 500 can include a frame 502, a rotation motor 504, and a lens-and-spring housing 506. For simplicity of illustration, mechanisms that support rotation motor 504 and lens-and-spring housing 506 are not shown in FIG. 5A.

Rotation motor 504 can be any direct current (DC) motor, stepper, or AC motor that rotates at a predetermined speed. Lens-and-spring housing 506 can have a circular outer body and can include an oblong cavity 508, which can enclose lens tube 510 and a spring 512. In one embodiment, spring 512 can be a wire spring. In alternative embodiments, spring 512 can be made of any elastic material that can compress and expand responsive to an external force. One end of spring 512 can be attached to or in contact with the inner wall of oblong cavity 508, and the other end of spring 512 can be attached to or merely in contact with lens tube 510. Lens tube 510 is not attached to the inner wall of oblong cavity 508. When lens-and-spring housing 506 remains stationary, spring 512 is expanded and pushes lens tube 510 against the corresponding end wall of oblong cavity 508. However, when spring 512 is compressed, lens tube 510 can slide within the inner wall of oblong cavity 508. Note that the shorter axis of oblong cavity 508 is slightly larger that the diameter of lens tube 510, providing the freedom for lens tube 510 to move along the longer axis of oblong cavity 508 but preventing movement along the shorter axis. In addition to the single-spring configuration shown in FIG. 5A, it is also possible to use multiple (e.g., two) springs inside oblong cavity 508.

The edge of rotation motor 504 can be in contact and engage with the edge of the circular body of lens-and-spring housing 506, such that the rotation of rotation motor 504 can drive or actuate the rotation of lens-and-spring housing 506. In FIG. 5A, the solid arrows that are opposite to each other indicate the rotation directions of rotation motor 504 and lens-and-spring housing 506. In this example, rotation motor 504 rotates clockwise, and lens-and-spring housing 506 rotates counterclockwise. It is also possible that they rotate in different directions than those shown in FIG. 5A.

During operation, rotation motor 504 can rotate at a predetermined speed, causing lens-and-spring housing 506 to rotate. Because their edges are in contact, the linear speeds of rotation motor 504 and lens-and-spring housing 506 can be the same, meaning that their angular speed can be reversely proportional to their radius. As lens-and-spring housing 506 rotates, the centrifugal force can push lens tube 510 away from the center of rotation, compressing spring 512. The range of movement of lens tube 510 can be controlled by controlling the rotation speed of rotation motor 504. In other words, a desired raster pattern can be generated by controlling the rotation speed of rotation motor 504. If the rotation speed varies in time, so will the raster pattern. In one embodiment, a continuously varying (e.g., from low to high and then from high to low) rotation speed can result in the raster pattern being an expanding and then contacting spiral pattern.

In the example shown in FIG. 5A, the motor driving the rotation of the lens-and-spring housing is situated outside of the housing. In alternative embodiments, it is also possible to use a hollow-core motor that can house the lens tube and the spring in its hollow core. In addition to using a spring to move/push the lens off center during rotation, in some embodiments, the lens can be placed in a fixed or permanent off-axis position with regard to the lens housing, such that when the lens housing rotates, the lens will make a circular motion.

FIG. 5B illustrates an exemplary rotation-based lens-motion system, according to one embodiment. A lens-motion system 520 can include a rotational lens housing 522, which can include a cavity 524 for housing a lens tube 526. In one embodiment, lens housing 522 and cavity 524 can be concentric, whereas lens tube 526 is positioned off center.

Rotational lens housing 522 can include a hollow core motor that rotates responsive to a drive current, and cavity 524 can be its hollow core. An opaque filling material can be placed between the inner wall of cavity 524 and lens tube 526 to fix the location of lens tube 526. Because lens tube 526 is off center of rotational lens housing 522, when rotational lens housing 522 rotates about its center, lens tube 526 will also move in a circle around the center of rotational lens housing 522. The radius of such circular motion can be the distance between the centers of rotational lens housing 522 and lens tube 526, as indicated by line segment 528 in FIG. 5B. In other words, the area of the raster scan can be determined by the distance between the two centers (i.e., the length of line segment 528).

Compared with other lens-motion systems (e.g., the systems shown in FIGS. 3A-5A), the off-axis lens-motion system has the advantage of being compact. The smaller footprint allows for application in space-constrained scenarios. Moreover, placing the lens inside the rotation motor also allows for a tighter seal when exposure to the elements is a concern. Considering that the filling material between the inner wall of cavity 524 and lens tube 526 is opaque, the likelihood of light leaking around lens tube 526 can be very low.

Note that when the filling material is rigid, the length of line segment 528 remains a constant. In other words, the raster scanning area remains a constant. In some embodiments, instead of a rigid material, a soft, flexible material (e.g., plastic, silicone, gel, rubber, etc.) can be used as the filling material. This way, similar to what is shown in FIG. 5A, when rotational lens housing 522 rotates, the centrifugal force may push lens tube 526 away from the rotation center. Hence, by configuring the rotation speed of rotational lens housing 522, one can configure the raster scanning area. A faster rotation speed can result in an increased length of line segment 528, and a slower rotation speed can result in a decreased length of line segment 528. If the rotation speed of rotational lens housing 522 varies with time, so will the area of the raster scanning. In one embodiment, during measurement, the rotation speed can increase, continuously, from a first predetermined value to a second predetermined value. Accordingly, the raster pattern can be an expanding spiral. In another embodiment, during measurement, the rotation speed can decrease, continuously, from one predetermined value to another, and the raster pattern can be a contracting spiral.

Raster Scanning with Bearings and Rails

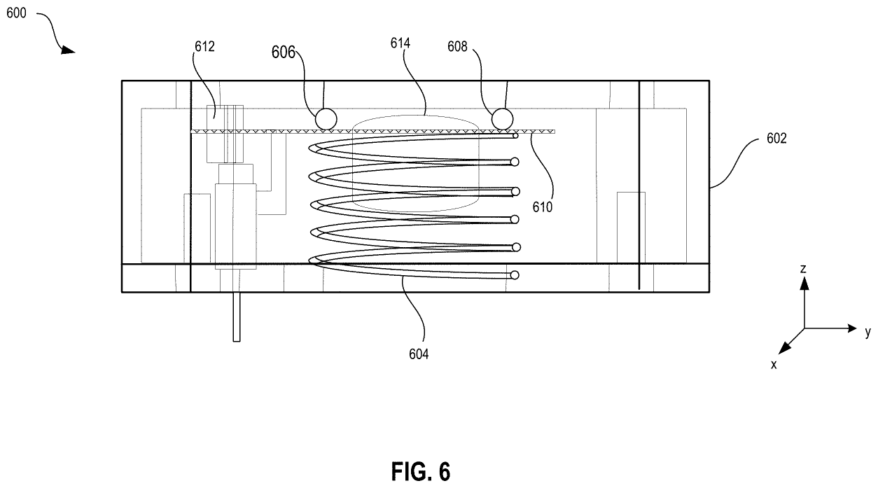

FIG. 6 illustrates an exemplary lens-motion system with a linear-bearing configuration, according to one embodiment. A lens-motion system 600 includes a supporting frame 602, a coil spring 604, a number of ball bearings (e.g., ball bearings 606 and 608), a shaking plate 610, a vibration motor 612, and a lens 614.

Supporting frame 602 can be similar to the one shown in FIGS. 3A and 3B and can enclose other components. Shaking plate 610 can be a rigid plate positioned between coil spring 604 and the ball bearings (e.g., bearings 606 and 608). More specifically, the spring force from coil spring 604 presses shaking plate 610 against the ball bearings, thus preventing shaking plate 610 from moving in the Z direction.

Vibration motor 612 is coupled to (e.g., attached to) shaking plate 610 such that the vibration of vibration motor 612 dives motion of shaking plate 610. Because shaking plate 610 in confined between coil spring 604 and the ball bearings, motion of shaking plate 610 is confined in the X-Y plane. In one embodiment, vibration motor 612 can cause shaking plate 610 to move (e.g., shake in a random pattern) in the plane between coil spring 604 and the ball bearings.

Lens 614 is attached to shaking plate 610. In one embodiment, shaking plate 610 can include an aperture, and lens 614 can fit into the aperture snugly. This way, when shaking plate 610 moves in the X-Y plane, lens 614 also moves in the X-Y plane. In some embodiments, shaking plate 610 can rotate or perform circular movements, and the range of the movement can be determined by the speed of vibration motor 612. Hence, the raster pattern of lens 614 can be controlled by configuring the speed of vibration motor 612. In one embodiment, the speed of vibration motor 612 can vary with time, thus leading to a time-varying rater pattern.

One advantage provided by the linear-bearing configuration is that the divergence angle of lens 614 is well-controlled during vibration, because shaking plate 610 is constrained by the ball bearings and coil spring 604. The ball bearings can also reduce noise resulting from mechanical friction. Moreover, the opaque nature of shaking plate 610 can also prevent light from leaking around lens 614, thus satisfying the light-blocking requirement.

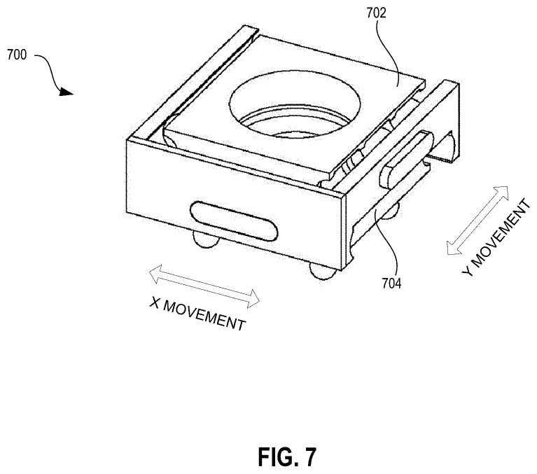

FIG. 7 illustrates an exemplary lens-motion system with linear rails, according to one embodiment. A lens-motion system 700 can include a pair of linear rail systems stacked on top of each other, with each linear rail system traveling in only one direction. For example, in FIG. 7, a linear rail system 702 traveling in the X direction is stacked on top of linear rail system 704 traveling in the Y direction. The excitation lens (not shown in FIG. 7) can be attached to the stacked linear rails such that it can move in the X-Y plane. For example, the excitation lens can be attached to a platform similar to the way lens 614 is attached to shaking plate 610 shown in FIG. 6, and the platform can be carried by the stacked linear rail systems such that it can move freely in the X-Y plane.

In some embodiments, voice coil actuators (VCAs) can be used to control the movement of the liner rail systems, which can provide great accuracy and speed in controlling the position of the excitation lens. Moreover, decoupling motions in the X and Y directions can also make it possible to generate arbitrary raster patterns. Theoretically speaking, any number of specific raster patterns can be generated.

The linear-rail configuration can also ensure that the angular displacement of the lens is minimized because the motion is constrained by the linear rails to a planar motion (e.g., in the X-Y plane). In addition, like shaking plate 610 shown in FIG. 6, the stacked rail structure (e.g., the platform) can also prevent light from leaking around the lens, thus satisfying the light-blocking requirement.

### Light-Blocking Mechanism

As discussed previously, light passing around the excitation lens may reach the detector, thus causing noise. Although a number of configurations of the lens-motion system have built-in light-blocking mechanisms (e.g., systems shown in FIGS. 5B-7), many other configurations (e.g., systems shown in FIGS. 3-5A) may encounter this light-leaking problem. For example, in the system shown in FIGS. 3A-3B, frame 302 needs to include an aperture to allow light to reach lens 316 enclosed within lens tube 312 and frame 302. Due to the motion of lens tube 312, the size of the aperture needs to be larger than the aperture size of lens tube 312, thus making it possible for light to pass frame 302 around lens tube 312. In some embodiments, a light-blocking rim around lens tube 312 can be used to cover the space between lens tube 312 and the aperture on frame 302, such that when lens tube 312 moves around within the aperture, the space between the edge of lens tube 312 and the edge of the aperture can be covered by the light-blocking rim.

To further ensure that no light can pass around the excitation lens (e.g., lens tube 312 shown in FIG. 3A), in some embodiments, the lens tube can include a multi-wall light-blocking structure, such that the tube walls and the outer frame of the lens-motion system can overlap multiple times at 90-degree angles. The multiple overlapping walls make it difficult for light to pass around the lens tube. Note that these overlapping walls can also serve as a mechanism for constraining the lens tube such that the lens tube can only perform planar motions.

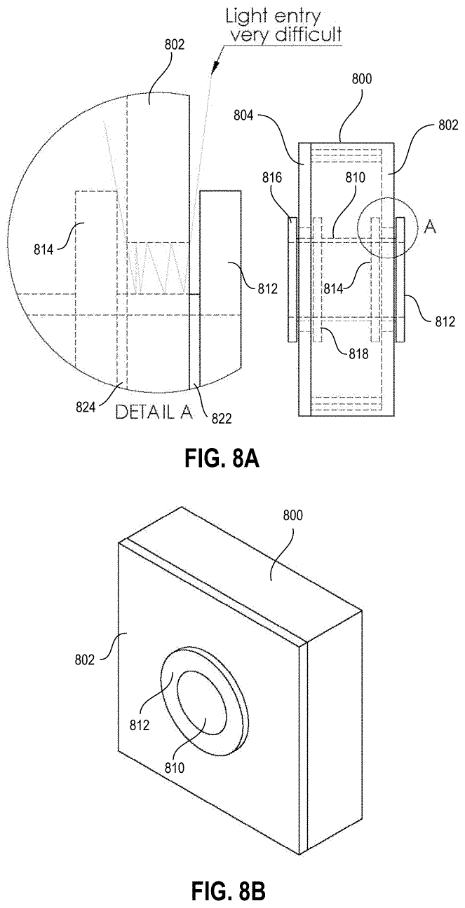

FIG. 8A illustrates the sideview of a lens-motion system implementing a light-blocking structure, according to one embodiment. The right drawing of FIG. 8A shows a frame 800 that includes a front wall 802 and a back wall 804. The right drawing of FIG. 8A also shows that a lens tube 810 is positioned within frame 800 between front wall 802 and back wall 804. Each end of lens tube 810 includes a double rim. More specifically, the front end of lens tube 810 includes rims 812 and 814 positioned on either side of front wall 802, and the back end of lens tube 810 includes rims 816 and 818 positioned on either side of back wall 804.

The left drawing of FIG. 8A shows the amplified/detailed view of area A. More specifically, it shows that there is an air gap between each rim and the adjacent wall. For example, there is an air gap 822 between rim 812 and front wall 802, and there is an air gap 824 between rim 814 and front wall 802. Similar air gaps exist between rims 816 and 818 and back wall 804. These air gaps allow the bobbin movements of lens tube 810 and prevent damage to surfaces of the components. However, the air gaps also provide a way for light to escape. Imagine that if there is only one rim at each end of lens tube 810, then it is possible that the light can enter the interior of frame 800 via the air gap at one end, reflect on the external surface of lens tube 810, and escape from the air gap at the other end. The double rim light-blocking structure shown in FIG. 8A makes it much harder for the light to enter frame 800, as shown by the possible light path in FIG. 8A.

FIG. 8B shows the perspective view of the lens-motion system implementing the light-blocking structure, according to one embodiment. More specifically, FIG. 8B shows front wall 802 of frame 800, and rim 812 of lens tube 810 is positioned on front wall 802. When lens tube 810 moves around with respect to frame 800, rim 812 and other rims that are not shown in FIG. 8B can effectively block external light from entering frame 800 around lens tube 810.

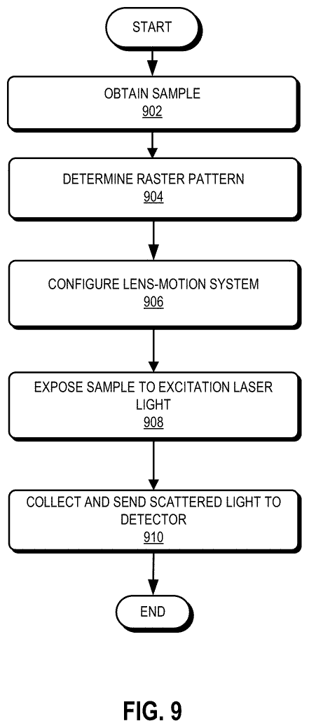

FIG. 9 presents a flowchart illustrating an exemplary process for measuring the optical spectrum of a sample, according to one embodiment. During operation, a to-be-tested sample can be obtained (operation 902). Depending on the application, the raster pattern can be determined (operation 904). For example, the raster area may be relatively large for inhomogeneous samples. Based on the determined raster pattern, the lens-motion system can be configured (operation 906). For example, depending on the raster area, the speed and/or drive strength of the motor(s) that actuate the movement of the excitation lens can be configured. In one embodiment, the spectrometer can include a control module that controls the speed and/or drive strength of the motor. In a further embodiment, the spectrometer can include a user interface that allows the field user to enter control commands to configure the speed and/or drive strength of the motor. The sample can then be exposed to the excitation laser light (operation 908). The exposure time can depend on the application. In most applications, the time interval during which the sample is exposed to the excitation laser light can be between 1 and 10 seconds. In one embodiment, the excitation lens can focus the laser beam onto the sample surface and the raster scanning of the excitation lens can cause the focused beam spot to scan a predetermined area on the sample surface. The scattered light can then be collected by the lens system and sent to the dispersive-and-detection optical module to determine the spectrum of the Raman scattered light (operation 910).

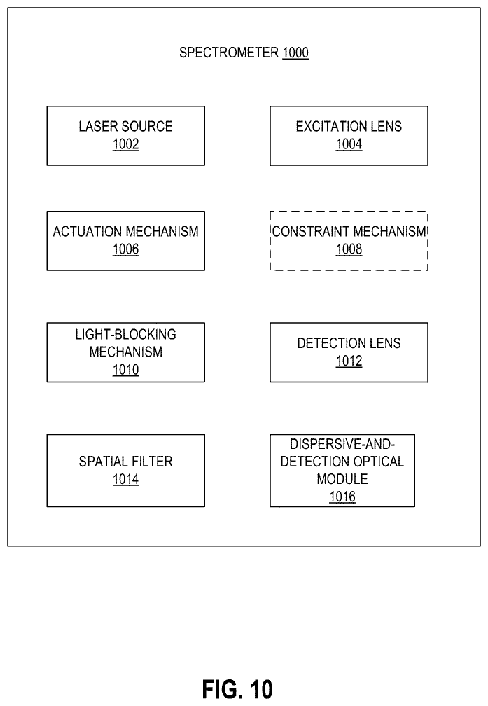

FIG. 10 illustrates a block diagram of a spectrometer implementing raster scanning, according to one embodiment. Spectrometer 1000 can include a laser source 1002, an excitation lens 1004, an actuation mechanism 1006, an optional constraint mechanism 1008, a light-blocking mechanism 1010, a detection lens 1012, a spatial filter 1014, and a dispersive-and-detection optical module 1016.

Laser source 1002 can be responsible for providing high-intensity excitation light to be shone on a sample. Excitation lens 1004 can be responsible for focusing the excitation light onto the sample surface. Actuation mechanism 1006 can be coupled to the excitation lens 1004 and, when activated, can cause excitation lens 1004 to move within a plane substantially perpendicular to the optical axis of excitation lens 1004. In one embodiment, actuation mechanism 1006 can include a supporting mechanism that supports excitation lens 1004 and a motor that actuates/disturbs the supporting mechanism, thereby causing excitation lens 1004 to move.

Constraint mechanism 1008 can be responsible for constraining the movements of excitation lens 1004 to the plane substantially perpendicular to its optical axis. Constraint mechanism 1008 is optional because, in some embodiments, actuation mechanism 1006 can include a built-in constraint mechanism. Light-blocking mechanism 1010 can be responsible for blocking the light from circumventing excitation lens 1004 to reach dispersive-and-detection optical module 1016. Detection lens 1012 can be responsible for focusing light from the sample excited by the excitation light onto dispersive-and-detection optical module 1016. Spatial filter 1014 can be a slit or a pinhole and can be responsible for blocking out-of-focus light from reaching dispersive-and-detection optical module 1016.

In general, the disclosed embodiments provide a system and method for realizing a low-cost, compact spectrometer with raster scanning. The spectrometer can include a laser source for generating excitation light, an excitation lens system for focusing the excitation light onto the sample surface, a dispersive-detection system for detecting the excited light signals, and a lens system for focusing the excited light onto the detector. More specifically, the excitation lens system can include an actuator that actuates the lens to move according to a predetermined or random movement pattern. Different types of actuators can be used, including but not limited to: one or more vibration motors, one or more rotation motors, one or more voice coil motors, etc. The moving lens system can result in the focused beam spot performing raster scanning. Raster scanning of the sample surface prevents damage to the sample surface and increases the accuracy of the measurement. In addition to one or more motors that drive the motion, the lens system also includes a constraining mechanism that can constrain the motion of the lens system to a plane perpendicular to the optical path to ensure that excited signals can reach the detector properly. Moreover, a light-blocking structure can be included in the excitation lens system to prevent light from circumventing the lens system to reach the detector. Although a Raman spectrometer is used in the various examples, similar raster scanning mechanisms can be used in other types of optical spectrometers.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An apparatus for facilitating raster scanning for an optical spectrometer, comprising:
an enclosure;
a lens holder positioned within the enclosure, wherein the lens holder is configured to hold a lens that focuses excitation light onto a sample surface; and
an actuation mechanism coupled to the lens holder, wherein the actuation mechanism is configured to cause the lens holder to perform a motion according to a predetermined pattern, thereby causing the focused excitation light to raster scan the sample surface.

2. The apparatus of claim 1, wherein the lens holder is mechanically coupled to internal walls of the enclosure via one or more springs, and wherein the actuation mechanism comprises at least one motor configured to compress or expand the springs.

3. The apparatus of claim 2, wherein the at least one motor is a vibration motor, and wherein the springs are flat springs.

4. The apparatus of claim 2, wherein the at least one motor is a rotation motor configured to cause the lens holder to rotate off axis.

5. The apparatus of claim 4, wherein the at least one motor comprises a hollow core, and wherein the lens holder and the one or more springs are situated inside the hollow core.

6. The apparatus of claim 1, wherein the lens holder is coupled to a shaking plate, and wherein the actuation mechanism comprises at least one motor configured to cause the shaking plate to move in a plane perpendicular to an optical axis of the lens.

7. The apparatus of claim 1, wherein the lens holder is coupled to a linear rail system, and wherein the actuation mechanism comprises a voice coil actuator.

8. The apparatus of claim 1, further comprising a constraint mechanism configured to constrain motions of the lens holder to a plane that is substantially perpendicular to an optical axis of the lens.

9. The apparatus of claim 1, further comprising a light-blocking mechanism surrounding the lens holder configured to prevent light from circumventing the lens holder to reach the detector.

10. The apparatus of claim 1, further comprising an actuation control mechanism configured to control one or more parameters of the actuation mechanism in order to control a motion pattern of the lens holder.

11. An optical spectrometer, comprising:
a light source configured to provide excitation light;
an excitation lens system configured to focus the excitation light onto a sample surface; and
a detector configured to detect signals excited by the excitation light from the sample surface;
wherein the excitation lens system comprises a lens and an actuation mechanism coupled to the lens, and wherein the actuation mechanism is configured to cause the lens to perform a motion according to a predetermined pattern, thereby causing the focused excitation light to raster scan the sample surface.

12. The optical spectrometer of claim 11, wherein the lens is coupled to one or more springs, and wherein the actuation mechanism comprises at least one motor configured to compress or expand the springs.

13. The optical spectrometer of claim 12, wherein the at least one motor is a vibration motor, and wherein the springs are flat springs.

14. The optical spectrometer of claim 12, wherein the at least one motor is a rotation motor configured to cause the lens to rotate off axis.

15. The optical spectrometer of claim 14, wherein the at least one motor comprises a hollow core, and wherein the lens and the one or more springs are situated inside the hollow core.

16. The optical spectrometer of claim 11, wherein the lens is coupled to a shaking plate, and wherein the actuation mechanism comprises at least one motor configured to cause the shaking plate to move in a plane perpendicular to an optical axis of the lens.

17. The optical spectrometer of claim 11, wherein the lens is coupled to a linear rail system, and wherein the actuation mechanism comprises a voice coil actuator.

18. The optical spectrometer of claim 11, further comprising a constraint mechanism configured to constrain motions of the lens to a plane that is substantially perpendicular to an optical axis of the lens.

19. The optical spectrometer of claim 11, further comprising a light-blocking mechanism surrounding the lens configured to prevent light from circumventing the lens to reach the detector.

20. The optical spectrometer of claim 11, further comprising an actuation control mechanism configured to control one or more parameters of the actuation mechanism in order to control a motion pattern of the lens.
